(19) United States
(12) Patent Application Publication
(10) Pub. No.: US 2009/0315346 A1
(43) Pub. Date: Dec. 24, 2009

(54) BUMPER REINFORCEMENT EXTENSION

(76) Inventors: David William Schelberg, Birmingham, MI (US); Mingher Fred Shen, Ann Arbor, MI (US)

Correspondence Address: DINSMORE & SHOHL LLP, 1900 CHEMED CENTER, 255 EAST FIFTH STREET, CINCINNATI, OH, 45202, US

(21) Appl. No.: 12/143,242

(22) Filed: Jun. 20, 2008

(51) Int. Cl. B60R 19/34

(52) U.S. Cl. 293/133

(57) ABSTRACT

Embodiments of a vehicle bumper reinforcement system comprise bumper fascia configured to couple to a vehicle body and operable to deform in response to a collision, a bumper reinforcement beam operable to couple to a vehicle body at a position spaced underneath the bumper fascia, and a bumper reinforcement extension disposed on a top edge of the bumper reinforcement beam, wherein the bumper reinforcement extension extends within a portion of the spacing between the bumper reinforcement beam and the bumper fascia. The bumper fascia is configured to deform and contact the bumper reinforcement beam and the bumper reinforcement extension in response to a collision, the position of the bumper reinforcement extension below the bumper being configured to reduce the deformation distance of the bumper fascia.

### TECHNICAL FIELD

Embodiments of the present invention are generally directed to systems and methods for vehicle bumper reinforcement, and are specifically directed to vehicle bumper reinforcement systems comprising bumper reinforcement extensions to prevent a vehicle from riding under a deformable barrier.

### BACKGROUND

Collision testing, which is devoted to minimizing vehicle damage and passenger injuries and fatalities, is a common practice in vehicle design and production. New Insurance Institute of Highway Safety (IIHS) test procedures use deformable barriers for impact evaluations instead of flat walls. As a result of these collisions, vehicles may ride under the deformable barrier, thereby damaging sheet metal and other portions of the vehicle. As a result, there is a need for vehicle bumper reinforcement systems which comply with IIHS test procedures and minimize vehicle damage.

### SUMMARY

According to one embodiment, a vehicle bumper reinforcement system is provided. The vehicle bumper reinforcement system comprises bumper fascia configured to couple to a vehicle body and operable to deform in response to a collision, a bumper reinforcement beam operable to couple to a vehicle body at a position spaced underneath the bumper fascia, and a bumper reinforcement extension disposed on a top edge of the bumper reinforcement beam, wherein the bumper reinforcement extension extends within a portion of the spacing between the bumper reinforcement beam and the bumper fascia. The bumper fascia is configured to deform and contact the bumper reinforcement beam and the bumper reinforcement extension in response to a collision, wherein the position of the bumper reinforcement extension below the bumper fascia is configured to reduce the deformation distance of the bumper fascia.

According to another embodiment, a method of protecting a vehicle during a collision with a deformable barrier is provided. The method comprises providing a vehicle comprising bumper fascia and a bumper reinforcement beam spaced underneath the bumper fascia, and attaching a bumper reinforcement extension onto a top edge of the bumper reinforcement beam at least partially within the spacing between the bumper reinforcement beam and the bumper fascia. The bumper reinforcement extension minimizes a deformation distance of the bumper fascia in response to a collision with a deformable barrier thereby preventing the vehicle from riding under the deformable barrier.

These and additional features provided by the embodiments of the present invention will be more fully understood in view of the following detailed description, in conjunction with the drawings.

### BRIEF DESCRIPTION OF THE DRAWINGS

The following detailed description of specific embodiments of the present invention can be best understood when read in conjunction with the drawing enclosed herewith.

FIG. 1 is a cross-sectional view of the bumper reinforcement beam and bumper reinforcement extension thereon according to one or more embodiments of the present invention; and

FIG. 2 is a perspective view of the bumper reinforcement beam and bumper reinforcement extension thereon according to one or more embodiments of the present invention.

The embodiments set forth in the drawing are illustrative in nature and not intended to be limiting of the invention defined by the claims. Moreover, individual features of the drawings and invention will be more fully apparent and understood in view of the detailed description.

### DETAILED DESCRIPTION

Embodiments of the present invention are directed to vehicle bumper reinforcement systems which comply with International Institute of Highway Safety (IIHS) test procedures and thereby minimize vehicle damage by providing adequate overlap to ensure the vehicle bumper fascia does not ride under the deformable barrier. If the vehicle rides under the barrier, the test barrier may impact surrounding sheet metal and other parts causing undesired vehicle damage.

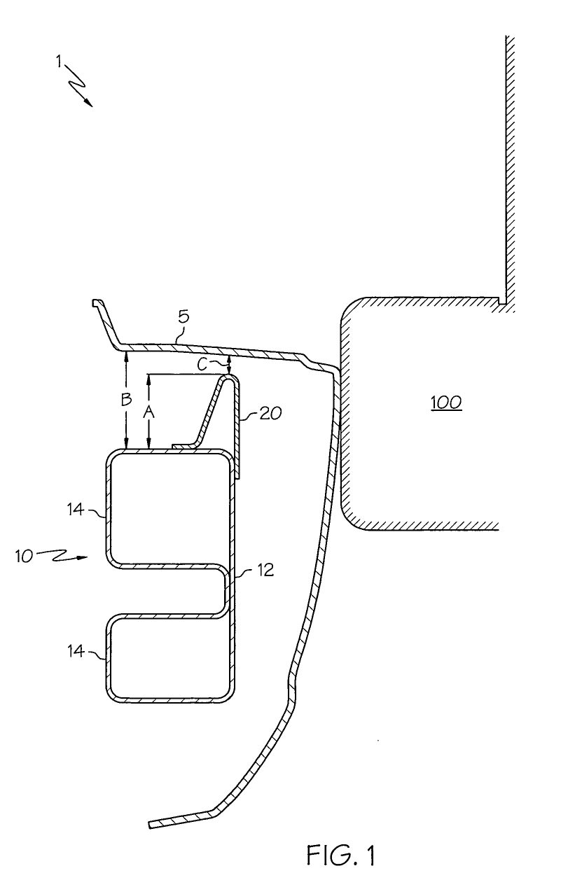

Referring to FIG. 1, the vehicle bumper reinforcement system 1 comprises bumper fascia 5 which attaches to a vehicle body. The bumper fascia 5 may be positioned at the front of the vehicle, the back of the vehicle, or both and may also extend along the sides of the vehicle. As defined herein, a “vehicle” may refer to any car, truck, sports utility vehicle, minivan or any other automobile known to one of ordinary skill in the art. As would be familiar to one of ordinary skill in the art, the bumper fascia 5 is configured deform in response to a collision, thereby absorbing part of the impact to the vehicle. The bumper fascia 5 may comprise a material which is able to flex and deform in response to a collision. For example, a flexible polymeric material may be used with or without a metal material for support.

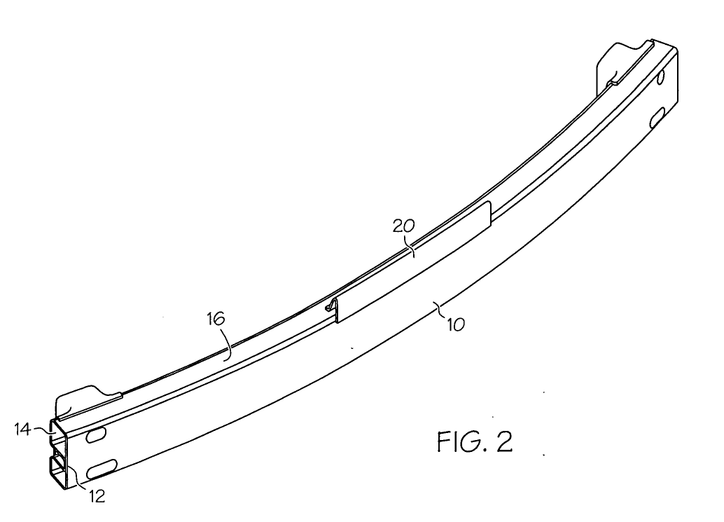

Referring again to FIGS. 1-2, the vehicle reinforcement system 1 also comprises a bumper reinforcement beam 10 positioned on a vehicle, but spaced a distance B underneath the bumper fascia 5. In one embodiment, the spacing between the bumper reinforcement beam 10 and the bumper fascia 5 may be approximately 50 millimeters. However, it should be understood that the bumper reinforcement beam 10 may comprise various shapes and structures as desired by the user. As shown in FIGS. 1-2, the bumper reinforcement beam 10 may comprise a curved shape to accommodate the contours of the vehicle body. The bumper reinforcement beam 10 may comprise a wall 12 and two subbeams 14 extending from the wall 12. The bumper reinforcement beam 10 may also comprise cutouts 16, which minimize the weight of the bumper reinforcement beam 10. Many materials are contemplated for the bumper reinforcement beam 10 including, for example, a rigid metal material, such as steel (e.g., M-190 high strength steel).

Referring again to FIG. 2, the vehicle reinforcement system 1 also comprises a bumper reinforcement extension 20 disposed on a top edge of the bumper reinforcement beam 10. The bumper reinforcement extension 20 may be attached to the bumper reinforcement beam 10 through various suitable processes (e.g., welding). The bumper reinforcement extension 20 extends within a portion of the spacing B between the bumper reinforcement beam 10 and the bumper fascia 5. Like the gap B between the bumper reinforcement beam 10 and the bumper fascia 5, there is a gap C between the bumper fascia 5 and the bumper reinforcement extension 20. The bumper reinforcement extension 20 comprises a height A sufficient to prevent the vehicle from riding under a deformable barrier 100. In a couple exemplary embodiments, the height of the bumper reinforcement extension A is about 30 to about 40 millimeters, whereas gap B is about 40 to 50 millimeters. The height A and B dimensions may vary; however, it has been found that a gap C of about 10 mm minimally is desirable.

Particularly, the gap C between the bumper reinforcement extension 20 and the bumper fascia 5 allows the bumper fascia 5 to deform in response a collision and thereby absorb a portion of the impact. However, the bumper reinforcement extension 20, which comprises a height A, minimizes the gap C between bumper reinforcement extension 20 and the bumper fascia 5 thereby allowing the bumper fascia 5 to deform a lesser distance. By deforming a lesser distance, the bumper fascia 5 is not so compacted that the vehicle under rides the deformable barrier 100, which results in significant vehicle damage such as to be the hood or the luggage door of the vehicle. As shown, the bumper reinforcement extension 20 allows the vehicle bumper reinforcement system 1 to provide adequate overlap while keeping the beam 10 in a location that meets packaging constraints and style requirements. Due to the minimized gap C between the bumper fascia 5 and bumper reinforcement extension 20, the deformable barrier cannot ride under the vehicle during a collision. The bumper reinforcement extension 20 may comprise various suitable shapes e.g., triangular shape.

Although various materials are contemplated herein, the bumper reinforcement extension 20 may comprise sheet metal, for example, a steel sheet with a thickness of about 1 mm. In operation, a collision with a deformable barrier 100 (e.g., a deformable barrier comprising size and performance properties as defined by the International Institute of Highway Safety) causes the bumper fascia 5 to deform. Referring to FIG. 2, when the bumper fascia 5 deforms, the bumper fascia 5 contacts the bumper reinforcement beam 10 and the bumper reinforcement extension 20.

For the purposes of describing and defining the present invention it is noted that the terms “substantially” and “about” are utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these aspects of the invention.

What is claimed is:

1. A vehicle bumper reinforcement system comprising:
bumper fascia configured to couple to a vehicle body and operable to deform in response to a collision;
a bumper reinforcement beam operable to couple to a vehicle body at a position spaced underneath the bumper fascia;
a bumper reinforcement extension disposed on an edge of the bumper reinforcement beam, wherein the bumper reinforcement extension extends within a portion of the spacing between the bumper reinforcement beam and the bumper fascia,
wherein the bumper fascia is configured to deform and contact the bumper reinforcement beam and the bumper reinforcement extension in response to a collision, the position of the bumper reinforcement extension below the bumper fascia being configured to reduce the deformation distance of the bumper fascia toward the bumper reinforcement beam.

2. The vehicle bumper reinforcement system of claim 1 wherein the bumper reinforcement beam is a metal beam.

3. The vehicle bumper reinforcement system of claim 1 wherein the bumper reinforcement extension comprises a steel sheet.

4. The vehicle bumper reinforcement system of claim 1 wherein the bumper reinforcement extension comprises a thickness of about 1 mm.

5. The vehicle bumper reinforcement system of claim 1 wherein the bumper reinforcement extension is welded to the bumper reinforcement beam.

6. The vehicle bumper reinforcement system of claim 1 wherein the bumper fascia comprises a front or rear bumper.

7. The vehicle bumper reinforcement system of claim 1 wherein the spacing between the bumper reinforcement beam and the bumper fascia is about 40 to about 50 mm.

8. The vehicle bumper reinforcement system of claim 1 wherein the spacing between the bumper reinforcement extension and the bumper fascia is at least about 10 mm.

9. A vehicle body comprising the vehicle bumper reinforcement system of claim 1.

10. The vehicle bumper reinforcement system of claim 1 wherein the vehicle bumper reinforcement system is provided on the front of the vehicle body and the rear of the vehicle body.

11. A method of protecting a vehicle during a collision with a deformable barrier comprising:
providing a vehicle comprising bumper fascia and a bumper reinforcement beam spaced underneath the bumper fascia;
attaching a bumper reinforcement extension onto an edge of the bumper reinforcement beam at least partially within the spacing between the bumper reinforcement beam and the bumper fascia, wherein the bumper reinforcement extension minimizes a deformation distance of the bumper fascia in response to a collision with a deformable barrier thereby preventing the vehicle from riding under the deformable barrier.

12. The method of claim 11 wherein the bumper reinforcement extension comprises the minimum height sufficient to ensure the vehicle from riding under the deformable barrier.

13. The method of claim 11 wherein the deformable barrier is a deformable barrier comprising size and performance properties as defined by the International Institute of Highway Safety.

14. The method of claim 11 wherein the bumper reinforcement extension is attached to the bumper reinforcement beam through welding.

15. The method of claim 11 wherein the spacing between the bumper reinforcement beam and the bumper fascia is about 40 to about 50 mm.

16. The method of claim 11 wherein the spacing between the bumper reinforcement extension and the bumper fascia is at least about 10 mm.
